(19) United States
(12) Patent Application Publication
(10) Pub. No.: US 2010/0304328 A1
(43) Pub. Date: Dec. 2, 2010

(54) TISSUE RETRACTOR

(76) Inventor: Philippe Schweizer, Beziers (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 12/446,319

(22) PCT Filed: Oct. 22, 2007
(86) PCT No.: PCT/FR07/52224

§ 371 Date: Apr. 20, 2009

(30) Foreign Application Priority Data
Oct. 20, 2006 (FR) 0654419

(51) Int. Cl. A61C 3/00

(52) U.S. Cl. 433/141

(57) ABSTRACT

The invention relates to a tissue retractor (2). Designed to be inserted between two tissues, for example between the maxillary bone (A) and the gingival tissue (B), it is in the form of at least one blade designed to allow the tissues (A, B) to be spread apart from each other and to be maintained between said tissues simultaneously. The retractor according to the invention can have a shape memory and can have apertures (23).

### BACKGROUND OF THE INVENTION

(1) Field of the Invention

The present invention relates to a tissue retractor, particularly suited to maintain a certain distance between the maxillary bone and the gingival tissue within the framework of ondontologic interventions.

The invention relates to the field of the surgery, in particular dental surgery.

(2) Description of the Prior Art

In the field of the dental surgery, when it is necessary to intervene at the level of an area of the tooth covered with gingiva, the use of gingival refraction cords is known. These cords are intended to be inserted into the gingival crevice or gingival sulcus located between the tooth and the gingiva, in order to maintain the gingiva at a distance from the tooth at the moment of an intervention.

There are also known gingival retractors intended to be inserted between a tooth and the gingival tissue, in order to intervene on said tooth. These can also be used for taking a mold of the tooth for making a tooth prosthesis. In these two cases, the gingival retractors allow the widening of the gingival sulcus either by retraction, or by gingival ejection.

However, these cords or retractors prove inefficient for an intervention on the maxillary bone, which no gingival sulcus permits to reach. In this case, an incision is necessary to reach the bone.

Thus, in the field of the dental surgery, and when it is necessary to intervene in particular under the gingiva, for example on the bone, the dental surgeon uses tools permitting, upon incision, to maintain the tissue gingival away from the area to be treated.

Thus, from U.S. Pat. No. 4,232,660 is known a surgical device in the form of a tunnel-shaped blade extending at the end of a handle that is to be held in the hand, which operation is generally performed by an assistant. This tool has the serious disadvantage, in the event of insertion into the patient's mouth, of preventing the mouth to be closed.

Moreover, maintaining the gingival tissue away from the bone presently occurs by means of a tool that has to be held by the assistant, as indicated above.

### SUMMARY OF THE INVENTION

Thus, it is within the framework of an inventive step that a tissue retractor has been devised, which permits to retract and maintain two tissues spread apart from each other, whereby one of tissues can be a bone or a cartilage, as in the particular case of the gingival tissue and the maxillary bone, suited for an intervention upon incision, in this case of the gingiva, and requiring only its placing by the practitioner to be operative.

To this end, the invention relates to a tissue retractor intended to be inserted between two tissues, for example between the maxillary bone and the gingival tissue, wherein it is in the form of at least one blade designed capable of permitting, simultaneously, the spreading apart of the tissues from each other and its maintaining between said tissues.

According to an embodiment of the invention, the blade or blades are made out of a material having elastic properties conferring them shape memory, the stable shape being the one permitting the spreading apart of the tissues from each other.

According to an embodiment, the tissue retractor according to the invention consists of a spring blade having a stable tunnel shape.

According to another embodiment, the tissue retractor according to the invention is in the form of a V-folded blade so as to form two parts conferring the unit a stable open-pliers shape.

According to another embodiment of a tissue retractor according to the invention, the blade includes at least one body and at least one cut-out permitting to define at least one fin connected to the body through at least one area of lesser strength, in order to permit a variation of the positioning of the fin with respect to the body, in particular by folding.

Advantageously, and in all its embodiments, the tool that results from this invention is enough per se to maintain a tissue, in particular a gingival tissue, at a certain distance from the area of treatment during an intervention on a tissue or an underlying bone such as the maxillary bone, or between two tissues, as in the case of the maxillary bone and the gingival tissue.

The tissue retractor according to some embodiments of the invention, which is easy to be placed, and in its ondontologic application has an efficient action as a gingiva retractor upon recovering of the stable shape of the blades forming the retractor: the retraction of the gingiva follows immediately, without difficulties, upon the placing of the retractor. The same applies to any other surgical application of insertion between tissues where the placing alone guarantees the spreading apart.

Once in place, no further human handling is necessary to maintain the tissue formed by the gingiva, thus reducing the additional risk of injury due to an involuntary movement of the patient or the assistant and the disturbance of the practitioner, who must operate in an accurate way on a difficultly accessible area, which is the inside of the mouth.

The tissue retractor according to another embodiment of the invention, and in its ondontologic application, provided the practitioner with the possibility of activating the retractor on request, while adapting the spreading apart of the tissue to his needs.

Other objectives and advantages of the present invention will clearly appear from the following description, which refers to exemplary embodiments given by way of an indication and non-restrictively.

### BRIEF DESCRIPTION OF THE DRAWINGS

The understanding of this description will be facilitated when referring to the attached drawings.

FIG. 1 schematically shows a tissue retractor according to a first embodiment of the invention, positioned between the maxillary bone and the gingival tissue, so as to maintain the gingival tissue separated from the bone during the surgical operation.

FIG. 2 shows the same situation as in FIG. 1, but seen from the front with respect to the tissue retractor.

FIG. 3A schematically shows, seen from above a tissue retractor according to a first variant of a second embodiment of the invention, positioned between the maxillary bone and the gingival tissue.

FIG. 3B schematically shows, seen from above a tissue refractor according to a second variant of a second embodiment of the invention, in the same positioning as in FIG. 3A.

FIGS. 4A, 4B and 4C schematically show, in a profile view, various steps of the insertion, between the maxillary bone and the gingival tissue, of a tissue retractor according to the second embodiment of the invention as shown in FIGS. 3A and 3B.

FIGS. 5A, 5B, 5C and 5D schematically show, seen from above, tissue retractors according to a third embodiment of the invention.

FIG. 6 schematically shows, in a perspective view, a tissue retractor according to a third embodiment, as positioned in situ during a dental surgical operation.

### DETAILED DESCRIPTION OF THE PREFERRED EMBODIMENTS

As can be seen in the attached figures, the present invention relates to the field of the surgery, namely dental surgery, and relates in particular to a tissue retractor intended, through its placing, to maintain a certain distance between the maxillary bone A and the gingival tissue B.

This retractor is therefore inserted between the maxillary bone A and the gingival tissue B by means of a previous incision C of the gingival tissue B.

A tissue retractor according to the invention can be in the form of a blade having spring properties and shape memory so that the stable form is such that it permits, once the gingival retractor has been positioned between the maxillary bone A and the gingival tissue B, a separation of the gingival tissue B with respect to the maxillary bone A.

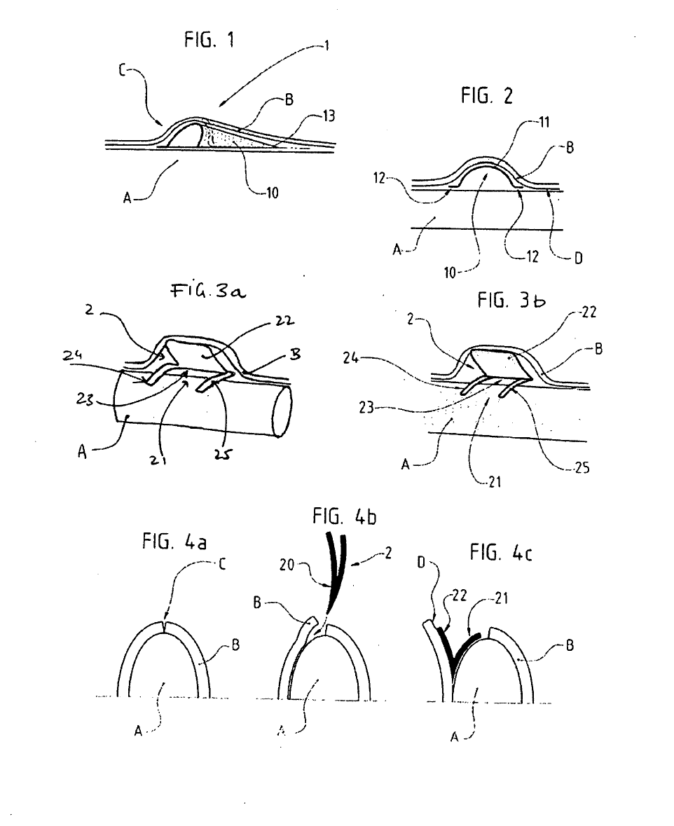

In a first embodiment of a tissue retractor 1 according to the invention, as shown in FIGS. 1 and 2, it is comprised of a blade 10 having, in its stable shape, a concave curve conferring same a cross-section having the shape of a portion of a cylinder.

In this embodiment, the curve of blade 10 permits to obtain a tunnel-shaped tissue retractor 1, the plain portion 11 of the blade 10 entering into contact with the gingival tissue B in order to lift it, the two side ends 12 of the blade 10 resting on the maxillary bone A.

It will be understood that the insertion and the placing of such a tissue retractor 1 are then facilitated by the elastic properties of blade 10. Since the latter is flexible, it will be possible to flatten it in order to slide it into the incision C made in the gingival tissue B. By releasing the pressure on the blade 10, the latter will recover its stable shape while lifting the gingival tissue B and while making the maxillary bone A accessible to the practitioner.

One can thus see that the placing of the tissue retractor 1 is closely related to its action of spreading apart of the gingival tissue B in order to expose the maxillary bone A.

As shown in FIG. 1, the curved blade 10 having in particular a stable shape of a half-cone advantageously permits to obtain a tissue retractor having an elongated shape, the point 13 of the half-cone permitting an easy insertion into the incision C of the gingival tissue B.

It is obvious that the blade 10 can have alternative stable shapes, the half-cone shape being only one preferred embodiment.

According to an alternative embodiment, not shown, the blade 10 can have apertures or openings in its surface, this solution being particularly advantageous if one wants to treat not only the maxillary bone A exposed by the tissue retractor 1, but also portions of the gingival tissue B on its face D usually in front of the maxillary bone A.

Thus, the end 13 of the half-cone can be truncated so as to enable the practitioner to reach the hidden face D of the gingival tissue at the end of the tunnel. Advantageously, this solution of a truncated half-cone also permits to lift the gingiva beyond the limit of insertion of the tunnel-shaped tissue retractor while reducing the risks of injuries that can be caused by a sharp end entering into contact with the gingival tissue.

As shown in FIG. 1, the blade 10 can also have legs at the level of its rests on the maxillary bone A. These legs, by widening the surface of contact of the blade 10 with the maxillary bone A, advantageously serve to maintain in place a regeneration membrane that covers the maxillary bone A and is placed by the surgeon.

According to a second embodiment shown in FIGS. 3A and 3B, a tissue refractor 2 according to the invention can be in the form of a V-folded blade 20 so as to form two portions 21 and 22, conferring to the unit a stable open-pliers shape.

According to a first variant of this second embodiment, as shown in FIG. 3A, the blade 20 includes two partial side cut-outs defining two thin leaves 24 and 25 on both sides of the central body of the blade 20. By folding the two thin leaves 24 and 25 with respect to the central body of the blade 20, one obtains two portions 21 and 22, the portion 21 comprised of the two thin leaves 24 and 25, maintaining and pushing the tissue retractor 2 away from the maxillary bone A, the portion 22 permitting to push the gingival tissue B to a distance away from the area to be treated. The opening 23 defined by the space between the two thin leaves 24 and 25 allows the practitioner to reach the surface of the maxillary bone A to be treated.

According to a second variant of this second embodiment, as shown in FIG. 3B, the V-shape can also be achieved thanks to two portions 21 and 22 co-operating mechanically at one of their ends. In this case, the thin leaves 24 and 25 do not result from a cut-out, and are not folded with respect to the body of the blade 20, but cooperate, for example through gluing, with a portion 22 of the blade 20.

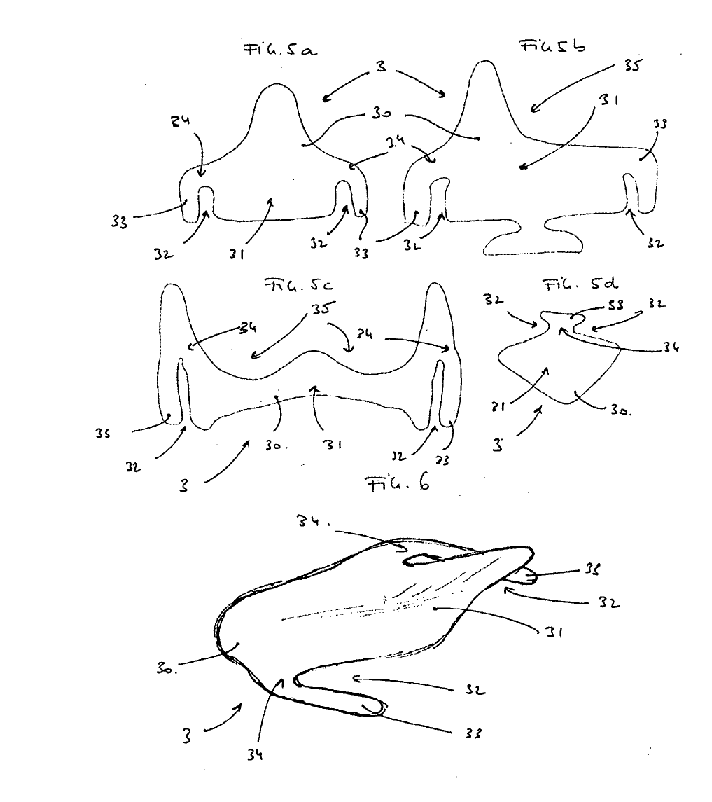

The FIGS. 4A to 4C show the successive steps of an insertion between the maxillary bone A and the gingival tissue B of a tissue retractor 2 according to the second embodiment of the FIGS. 3A and 3B. The practitioner first performs an incision C in the gingival tissue B, as schematically shown in FIG. 3A.

The tissue refractor 2, compressed so as to fold the two portions 21 and 22 against each other, is then inserted between the gingival tissue B and the maxillary bone A, as shown in FIG. 4B.

Finally, releasing the pressure maintaining the two portions 21 and 22 against each other allows, following the recovering of the stable shape of the tissue retractor 2, the separation of the gingival tissue B from the maxillary bone A as well as maintaining the tissue retractor 2 in position, as shown in FIG. 4C.

Nevertheless, if the two portions 21 and 22 of the tissue refractor 2 according to this embodiment are plain, both the internal face D of the gingival tissue B and the maxillary bone A are masked for the intervention by the practitioner.

In this context, one will understand the advantage of the solution shown in FIG. 4, where the portion 22 of the tissue retractor 2 lifting the gingival tissue B is plain and the portion 21 is open-worked so as to obtain two thin leaves 24 and 25 maintaining and pushing the tissue retractor 2 towards the maxillary bone A. Thus, the practitioner will be able to reach the surface of the maxillary bone A located in the open-worked portion 23 of the blade 21, between the two thin leaves 24 and 25.

The use of several tissue retractors 2 with the plain portions 21 and 22 can nevertheless prove interesting if one wants to treat an area located between the gingival retractors 2.

It is nevertheless obvious that the open-worked portion 23 can also be located in front of the internal face D of the gingival tissue B, or that the two portions 21 and 22 can be open-worked in this way.

In order to make them rigid, the two thin leaves 24 and 25 can, according to an embodiment not shown, be connected to each other by another thin leaf, so as to form a window-shaped aperture, surrounded on all sides by thin leaves.

Advantageously, the tissue refractor described in the first two embodiments is made out of any material having suitable elastic performances and biocompatible with a surgical use in contact with a mucous membrane.

When considering the retractors 1 and 2 as described, one nevertheless realizes that it would be advantageous for the practitioner to be able to define the separation between tissues in situ, which is not easy with the embodiments described. Indeed, if one takes in particular the exemplary retractor 2 shown in FIG. 3A, the separation in situ, once the retractor has been placed, largely depends on the separation in stable shape between the portions 21 and 22 of the retractor 2, as well as on the stiffness imposed by the materials used. Now, the practitioner cannot intervene on these parameters, in particular during the operation on the patient.

A third embodiment as shown in the diagrams of FIGS. 5A, 5B, 5C, 5D and 6 permits to solve this problem by providing a tissue retractor 3 defined by a blade 30 including a central body 31 and at least one cut-out 32 permitting to delimit, on the periphery of this central body 31, at least one fin 33.

The shape of blade 30 is advantageously dictated by the practitioner's needs. This variability is shown by the various alternative shapes of FIGS. 5A to 5D.

The shape and the dimensioning of the cut-outs 32 advantageously permit to define one or several areas 34 with a lesser torsion strength of the material the blade 30 is made of, in order to permit a varying positioning of the wing or wings 33 with respect to the central body 31, namely by a folding action at the level of these areas 34, This action can advantageously be carried out in situ by the practitioner upon insertion of the retractor 3 between the maxillary bone A and the gingival tissue B, in order to achieve, as shown in FIG. 6, a separation between both tissues A and B when entering into contact, on the one hand, with the body 31 and, on the other hand, with the wings 33, the separation being adapted in situ to the practitioner's needs or the possibilities of separation of the area to be treated.

The blade 30 is manufactured of one single piece, out of a suitable material for a surgical use and including suitable malleability characteristics, eventually because of its thickness, for example 20-micron thick surgical stainless steel or titanium.

The blade 30 can also include apertures or openings 35, as for example in the variant of FIG. 5C.

This last embodiment described advantageously permits an activation on request of the retractor according to the invention, while permitting to modulate the spreading apart desired depending on the practitioner's needs.

In all its embodiments, the tissue retractor according to the invention allows, at least in its ondontologic application, the patient's mouth to be closed during the intervention, which constitutes an appreciable advantage for the patient, but also for the practitioner, if he wants to align the teeth of both jaws or to thus visualize the distance between the maxillary bone and the antagonistic teeth.

As clearly appears from the preceding description, the present invention solves in an astute way the problem set forth. In particular, the solution according to the invention allows the dental surgeon to reach the maxillary bone in a simple way and without any particular assistance.

1. Tissue retractor intended to be inserted between two tissues, for example between the maxillary bone and the gingival tissue, wherein it is in the form of at least one blade designed capable of simultaneously permitting the spreading apart of the tissues from each other and its maintaining between said tissues.

2. Tissue retractor according to claim 1, wherein the blade or blades are made out of a material having elastic properties, which confer them a shape memory, the stable shape being the one allowing the spreading apart of the tissues from each other.

3. Tissue retractor according to claim 2, wherein the tissue retractor consists of a spring blade having stable tunnel-shape.

4. Tissue retractor according to claim 3, wherein the stable shape of the blade is in the form of a half-cone.

5. Tissue retractor according to claim 3, wherein the stable shape of the blade is in the form of a truncated half-cone.

6. Tissue retractor according to claim 1, wherein the tissue retractor is in the form of a V-folded blade the two portions of which on both sides of the folding confer to the unit a stable open-pliers shape.

7. Tissue retractor according to claim 1, wherein the blade includes at least one body and at least one cut-out permitting to define at least one fin connected to the body by at least one area of lesser strength, in order to permit a change in positioning of the fin with respect to the body, namely by folding.

8. Tissue retractor according to claim 1, wherein the blades forming the tissue retractor have apertures or openings allowing access to an area to be treated.

9. Tissue retractor according to claim 2, wherein the tissue retractor is in the form of a V-folded blade the two portions of which on both sides of the folding confer to the unit a stable open-pliers shape.

10. Tissue retractor according to claim 2, wherein the blades forming the tissue retractor have apertures or openings allowing access to an area to be treated.

11. Tissue retractor according to claim 3, wherein the blades forming the tissue retractor have apertures or openings allowing access to an area to be treated.

12. Tissue retractor according to claim 4, wherein the blades forming the tissue retractor have apertures or openings allowing access to an area to be treated.

13. Tissue retractor according to claim 5, wherein the blades forming the tissue retractor have apertures or openings allowing access to an area to be treated.

14. Tissue retractor according to claim 6, wherein the blades forming the tissue retractor have apertures or openings allowing access to an area to be treated.

15. Tissue retractor according to claim 7, wherein the blades forming the tissue retractor have apertures or openings allowing access to an area to be treated.

16. Tissue retractor according to claim 9, wherein the blades forming the tissue retractor have apertures or openings allowing access to an area to be treated.
